(19) United States
(12) Patent Application Publication
(10) Pub. No.: US 2008/0095964 A1
(43) Pub. Date: Apr. 24, 2008

(54) SUPPLEMENTAL LABEL

(75) Inventors: Mike Wilkinson, Overland Park, KS (US); William Armstrong, DeSoto, KS (US)

Correspondence Address: LATHROP & GAGE LC, 2345 GRAND AVENUE, SUITE 2800, KANSAS CITY, MO, 64108, US

(73) Assignee: Vestcom New Century LLC

(21) Appl. No.: 11/686,481

(22) Filed: Mar. 15, 2007

Related U.S. Application Data
(63) Continuation of application No. 11/670,284, filed on Feb. 1, 2007.

(51) Int. Cl. B32B 33/00; B32B 7/12

(52) U.S. Cl. 428/40.1; 428/343; 428/354

(57) ABSTRACT

Supplemental labels and methods of manufacturing supplemental labels are disclosed herein. A supplemental label according to an embodiment includes a presentation portion having a front face and a coupling portion coupled to the presentation portion. The front face has a printable area and includes a print-receiving medium. The coupling portion is transparent and has opposed front and rear faces. The rear face has an adhesive, and at least a portion of the adhesive is exposed to removably couple the coupling portion to the object. A supplemental label according to an embodiment includes a presentation portion having a front face and a coupling portion coupled to the presentation portion. The front face has a printable area and includes a print-receiving medium. The coupling portion is transparent, has opposed front and rear faces, and extends beyond the presentation portion. The rear face of the coupling portion has a transparent adhesive.

### RELATED APPLICATIONS

This application is a continuation of U.S. patent application Ser. No. 11/670,284 filed Feb. 1, 2007 and titled “Method Of Manufacturing A Supplemental Label”, which is incorporated herein by reference.

### BACKGROUND

The present invention relates generally to labeling, and in particular to retail shelf labeling with printed labels having transparent sections and methods of making the same.

Printed labels comprise an important form of communication. Labels are commonly used for conveying information in a wide range of applications. In the retail sector, for example, labels are commonly applied to product displays (i.e., “point-of-sale” displays) to identify objects and to convey information about those objects to customers. Retail establishments may employ various types of labels to communicate such product information as pricing, product identification, etc.

In retail establishments, product information tends to be dynamic in that product offerings and pricing undergo frequent changes. Point-of-sale product labeling is often changed by applying new labels to shelves on which the products are displayed. Such shelf labeling is a significant part of the labeling activity in retail commercial establishments, and the frequent relabeling which occurs in many stores consumes significant labor resources.

Many prior art labels are adhesively attached to the shelf edges in a manner that requires excessive labor to remove the labels before being updated with replacements. Improvements have been made to these basic adhesive labels to reduce the bond between the labels and shelves through employing various types and amounts of adhesive. While these improved labels reduce the labor required to update the information, they are generally meant as replacements for the outdated labels and do not allow the consumers to view the prior product information unless that information is included on the new label. If an item is “on sale”, for example, the store owner may want the consumers to see the original price of the item. Additionally, barcode information and other static (unchanging) information has to be printed on each new label.

Another prior art labeling system is disclosed in U.S. Pat. No. 6,632,316. This system uses labels removably placed inside transparent label display strips to avoid the labor associated with removing labels that have been adhesively bonded to shelves. While outdated labels can be easily replaced by new labels in this system, the consumers still are not typically able to view the prior product information unless that information is included on the new label. Barcode information and other static information has to be printed on each new label.

One prior art label is made of paper and has a “window” covered by a transparent laminate (similar to many envelope windows). Two-sided transparent tape is then coupled to the transparent laminate so that the label may be attached to a store shelf and an underlying label can be seen through the window. While this addresses some of the problems noted above, the two-sided tape coupled with the laminate can make the underlying label difficult to see, the portion of the label surrounding the window requires undue attention in applying the label over the underlying label, and the portion of the label surrounding the window can make the underlying label difficult to see even if care is taken when applying the label. In addition, the manufacture of this label is unnecessarily complicated and expensive.

While a prior art flag is known that has a first end of clear film with adhesive and an opposed second end of paper or clear film without adhesive, the second end has predetermined printed material and this flag does not allow a user (e.g., a store manager) to customize the printed material. As such, the flag is of little use besides drawing attention to a product. The known prior art embodiment of this flag that has opposed ends of clear film is manufactured by printing on the clear film and adding adhesive to one of the ends. The known prior art embodiment of this flag that has one end of clear film and an opposed end of paper is manufactured by adding adhesive to the clear film and using the adhesive to attach the clear film to part of the paper. A removable backing material is then applied to the exposed adhesive. Due to the method of manufacture, a strip of the exposed adhesive approximately half a millimeter wide is often left uncovered by the backing. This uncovered adhesive can attract debris or be otherwise undesirable.

A supplemental label is needed that can be adhesively attached to a shelf, label display strip, or other suitable device so that the underlying label can be easily viewed through the supplemental label. Further, the supplemental label needs to allow a user to customize the material printed thereon. Methods of manufacturing such supplemental labels are also needed.

### SUMMARY

A supplemental label according to an embodiment includes a presentation portion having a front face and a coupling portion coupled to the presentation portion. The presentation portion front face has a printable area and includes a print-receiving medium. The coupling portion is transparent and has opposed front and rear faces. The rear face has an adhesive, and at least a portion of the adhesive is exposed to removably couple the coupling portion to the object.

A supplemental label according to an embodiment includes a presentation portion having a front face and a coupling portion coupled to the presentation portion. The presentation portion front face has a printable area and includes a print-receiving medium. The coupling portion is transparent, has opposed front and rear faces, and extends beyond the presentation portion. The rear face of the coupling portion has a transparent adhesive.

A method of manufacturing a supplemental label according to an embodiment includes the steps of providing a paper material; providing a strip of transparent film having a front face and a rear face having transparent adhesive; coupling the strip of transparent film to the paper material; and perforating the paper material and the transparent film to define a plurality of supplemental labels.

A method of manufacturing a supplemental label according to an embodiment includes the steps of providing a paper material; providing a liner; providing a strip of transparent film having a front face and a rear face having transparent adhesive; coupling the paper material to the liner; cutting a strip of the paper material; separating and removing the strip of paper material from the liner to expose a portion of the liner; coupling the strip of transparent film to the exposed portion of the liner and to an adjacent edge of the paper material; and cutting the transparent film and the paper material to define a plurality of supplemental labels removable from the liner.

A method of manufacturing a supplemental label according to an embodiment includes the steps of providing a print-receiving medium; providing a liner; providing a strip of transparent film having a front face and a rear face having a transparent adhesive; coupling the print-receiving medium to the liner; cutting a strip of the print-receiving medium; separating and removing the strip of the print-receiving medium from the liner to expose a portion of the liner; and coupling the strip of transparent film to the exposed portion of the liner and to the print-receiving medium.

A method of manufacturing a supplemental label according to an embodiment includes the steps of providing a print-receiving medium; providing a liner; providing a strip of transparent film having a front face and a rear face having a transparent adhesive; coupling the print-receiving medium to the liner so that at least one portion of the liner is exposed; and coupling the strip of transparent film to the exposed portion of the liner and to the print-receiving medium.

A method of manufacturing a supplemental label according to an embodiment includes the steps of providing a print-receiving medium; providing a liner; providing a strip of transparent film having a front face and a rear face having a transparent adhesive; introducing a pattern of release agent to the print-receiving medium; coupling the strip of transparent film to a portion of the print-receiving medium having the release agent and to a portion of the print-receiving medium without the release agent; and cutting the print-receiving medium so that the portion having the release agent is separable from the portion without the release agent and separable from the transparent film.

### BRIEF DESCRIPTION OF THE DRAWINGS

FIG. 1 is a front perspective view of a supplemental label according to an embodiment.

FIG. 2 is a rear perspective view of the supplemental label of FIG. 1.

FIG. 3 is a front perspective view of the supplemental label of FIG. 1 coupled to a shelf.

FIG. 4 is a slightly exploded side view of the supplemental label of FIG. 1.

FIG. 5 is a front view of a sheet of the supplemental labels of FIG. 1 according to an embodiment.

FIG. 6 is an exploded view of FIG. 5 with removed strips of material shown.

FIG. 7 is a side view of FIG. 5.

FIG. 8a is a side view of a stack of the sheets of FIG. 5.

FIG. 8b is a side view of a stack of sheets of supplemental labels according to an embodiment.

FIG. 9 is a diagram representing a manufacturing process according to an embodiment for creating the supplemental label of FIG. 1.

FIG. 10 is a front view of a sheet of the supplemental labels of FIG. 1 according to an embodiment.

FIG. 11 is an exploded view of FIG. 10.

FIG. 12 is a side view of FIG. 10.

FIG. 13 is a diagram representing a manufacturing process according to an embodiment for creating the supplemental label of FIG. 1.

### DETAILED DESCRIPTION

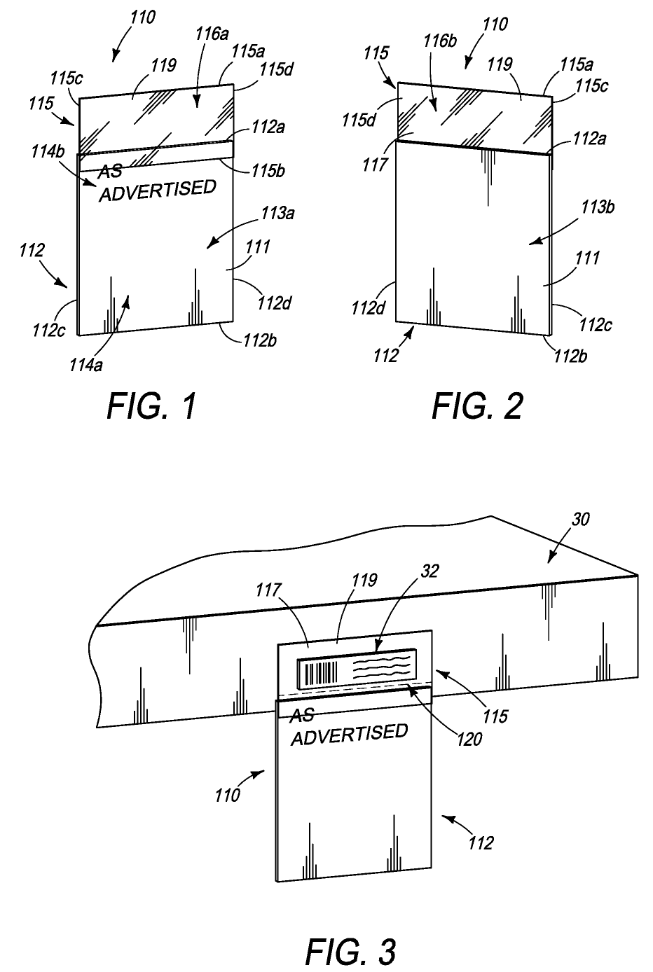

FIGS. 1 and 2 show a supplemental label 110 having a presentation portion 112 and a coupling portion 115. The presentation portion 112 has top and bottom ends 112a, 112b and opposed sides 112c, 112d. While the ends and sides 112a, 112b, 112c, 112d of the presentation portion 112 are shown to collectively be generally rectangular, non-rectangular configurations may alternately be defined.

The presentation portion 112 further includes a front face 113a (FIG. 1) and a rear face 113b (FIG. 2). The front face 113a may include an area 114a appropriate for being printed upon, such as a blank or otherwise inconspicuous field, so that information (e.g., price information, etc.) may be later printed on the area 114a using traditional printing technologies (e.g., a laser printer, a dot-matrix printer, a marker, a pen, etc.). The front face 113a may alternately or additionally include indicia 114b that does not readily lend the front face 113a to being printed upon. For example, the front face 113a may include graphics that would cause any additional printed material to be illegible or inconspicuous.

The presentation portion 112 is shown as a single layer of material 111 (e.g., paper, card stock, etc.), though additional layers may be included. The material 111 may be almost any print-receiving medium, such as paper material, cloth, etc., though inexpensive materials may be preferred and the material 111 may include various component materials. If the printable area 114a is included, it may be preferred that the front face 113a of the presentation portion 112 is not covered by a material that is difficult, impractical, or impossible to print upon.

The coupling portion 115 is shown to be a clear film 119 having top and bottom ends 115a, 115b and opposed sides 115c, 115d. While the ends and sides 115a, 115b, 115c, 115d of the coupling portion 115 are shown to collectively be generally rectangular and the coupling portion 115 is shown to have a width that is approximately equal to a width of the presentation portion 112, non-rectangular configurations and/or other widths may alternately be defined. As shown throughout the drawings, the coupling portion sides 115c, 115d may be unbounded beyond the presentation portion end 112a. In other words, it is not necessary to provide a border around the coupling portion sides 115c, 115d, though such a border may be used.

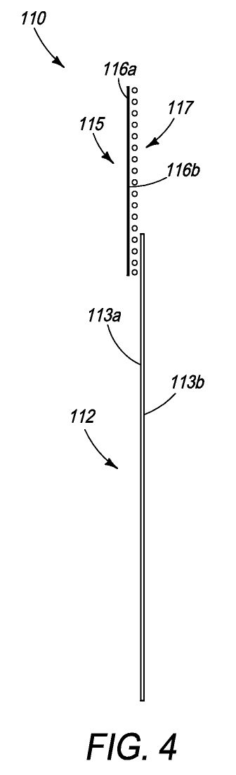

The coupling portion 115 has a front face 116a (FIG. 1) and a rear face 116b (FIG. 2), and the rear face 116b has an adhesive 117 (i.e., a transparent pressure-sensitive adhesive) that may be used to couple the coupling portion 115 to an object. For example, FIG. 3 shows the adhesive 117 coupling the coupling portion 115 to a store shelf 30 over another label 32. The adhesive 117 may also be used to affix the coupling portion 115 to the presentation portion 112, as shown in FIG. 4, so that the coupling portion 115 extends beyond the presentation portion 112. The coupling portion 115 may be sized to cover the label 32 (FIG. 3) or to only partially cover the label 32.

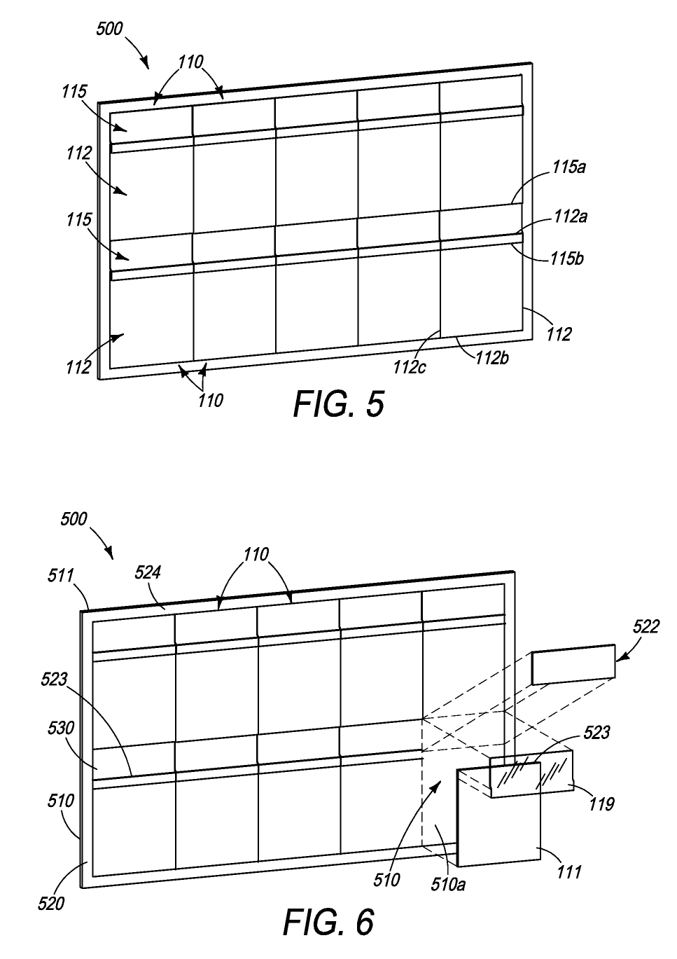

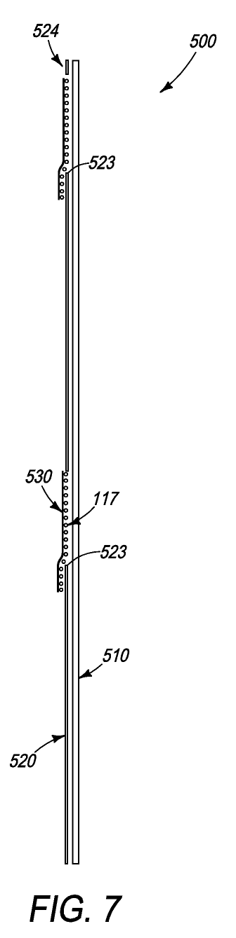

FIGS. 5 through 7 show a sheet 500 of the supplemental labels 110 according to an embodiment. The sheet 500 may be 8½ inches by 11 inches or any other appropriate size. The sheet 500 includes a substrate (or “liner”) 510 that has a front face 510a (FIG. 6) and a rear face (not shown). The front face 510a of the liner 510 may include a release agent (e.g., a silicone release, etc.) or be otherwise easily separable from adhesive bonds. A sheet 520 of the material 111 (e.g., paper, card stock, etc.) is atop the liner 510 and has strips 522 (FIG. 6) removed. Edges 523 of the sheet 520 are defined by the removal of the strips 522. The edges 523 correspond to the top ends 112a of the presentation portions 112. Strips 530 of the clear film 119 having adhesive 117 are atop the edges 523 of the sheet 520 and extend over the liner 510 where the strips 522 have been removed. The adhesive 117 affixes the clear film 119 to the sheet 520 and the liner 510; the coupling of the film 119 to the sheet 520 is intended to be permanent, while the release agent or nature of the liner 510 allows the bond between the film 119 and the liner 510 to be temporary. A plurality of the supplemental labels 110 are distinctly defined by the clear film 119 and the material 111, such as through a cutting step as discussed further below, and each supplemental label 110 may be easily removed from the liner 510.

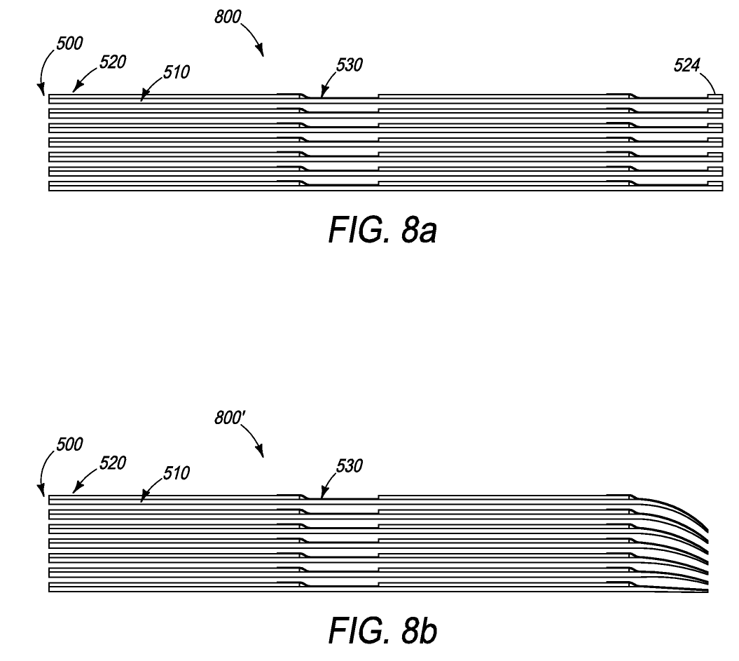

The removal of the strips 522 may leave a strip 524 of the sheet 520 adjacent an edge 511 of the liner 510 that does not define a presentation portion 112. This strip 524 may allow a stack 800 of the sheets 500 to remain generally level, as shown in FIG. 8a. Without this strip 524, a stack 800′ of the sheets 500 may slope, as shown in FIG. 8b. The sheets 500 are shown slightly exploded from one another in FIGS. 8a and 8b for clarity.

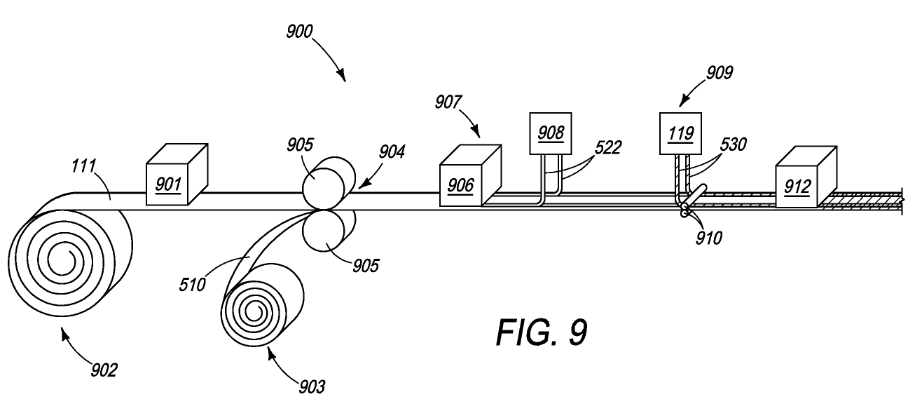

FIG. 9 shows a manufacturing process 900 according to an embodiment that may be used to create the sheets 500 of the supplemental labels 110. At a first station 901, indicia may be printed upon the material 111, such as through a laser printer, a dot-matrix printer, or another printing device. The material 111 may be provided as a roll 902 capable of being separated into many sheets 520, or single sheets 520 of the material 111 may be used. Before or after the indicia is printed upon the material 111, the material 111 may be coupled to the liner 510, which may also be provided as a roll 903 capable of being separated into many sheets or provided as single sheets. The coupling of the material 111 and the liner 510 occurs at a station 904 in FIG. 9. For example, the material 111 may be coupled to the liner 510 by a “wet trap” adhesive process whereby the material 111 is applied under pressure to the liner 510 before the adhesive dries. The material 111 may be adhered to the liner 510 under pressure using, for example, conventional press equipment such as rollers 905.

The material 111 may then proceed to a cutting tool 906 at station 907. The cutting tool 906 may create the strips 522 of the material 111 described above. A vacuum 908 or another suitable device may then separate and remove the strips 522 from the remainder of the material 111. While the material 111 has been described as already being coupled to the liner 510, it may be possible to couple the material 111 to the liner 510 after the strips 522 are removed.

After the material 111 is coupled to the liner 510 and the strips 522 have been removed, the strips 530 of the clear film 119 may be introduced at station 909 so that the adhesive 117 affixes the strips 530 to the material 111 and the liner 510. Conventional press equipment, such as rollers 910, may be used in coupling the strips 530 to the material 111 and the liner 510. Similar to the material 111 and the liner 510, the clear film 119 may be provided as rolls or sheets. The strips 530 of the clear film 119 are located so that the clear film 119 covers the exposed liner 510 and a portion of the material 111 that at least includes the edges 523.

Another cutting tool 912 may then cut through or perforate the material 111 and the clear film 119 to define a plurality of the supplemental labels 110 so that the individual supplemental labels 110 can be separated from the liner 510. If the material 111, the liner 510, and/or the clear film 119 is provided in rolls, the cutting tool 912 or another cutting tool (not shown) may separate the material 111, the liner 510, and the clear film 119 into the sheets 500 of the supplemental labels 110.

Returning to FIG. 3, a supplemental label 110 may be separated from a sheet 500 (FIG. 5) and coupled to the store shelf 30 over the other label 32 using the adhesive 117. Indicia may be printed on the sheet 500, such as by a laser or dot-matrix printer, before the supplemental label 110 is separated from the sheet 500. Because of the transparency of the coupling portion 115 (i.e., the clear film 119 and the adhesive 117), the other label 32 may still be viewed. Because the other label 32 may still be viewed, a customer can easily make comparisons between information on the supplemental label 110 and the other label 32, and there is no need for a product's barcode or other static data to be printed on the supplemental label 110. For example, a customer may see an original price on the other label 32 and a sale price on the supplemental label 110 and feel confident that the price has been lowered. Once the supplemental label 110 is no longer needed (e.g., a sale is over), the supplemental label 110 may be separated from the shelf 30 and leave and the other label 32 intact. To do this, it is important that the adhesive 117 is not too aggressive. However, the adhesive 117 must be strong enough to couple the clear film 119 to the shelf 30 as desired. Perforations 120 may be included generally between the coupling portion 115 and the presentation portion 112 as shown in FIG. 3 to allow the presentation portion 112 to be separated from the coupling portion 115. As such, the presentation portion 112 may be separated from the coupling portion 115 and the shelf 30, and the coupling portion 115 may remain over the other label 32.

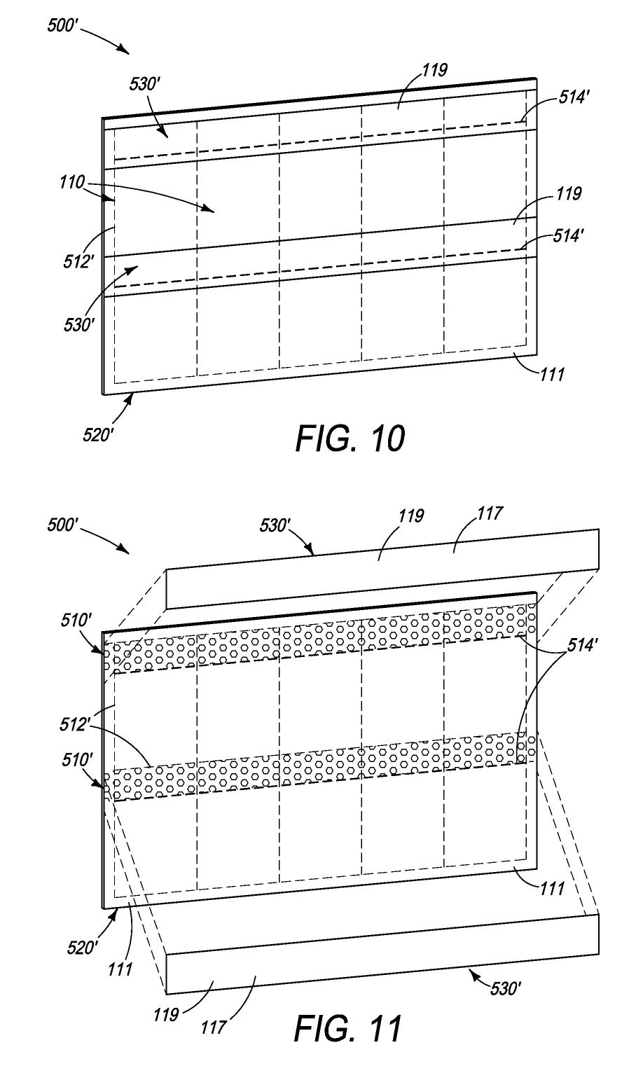

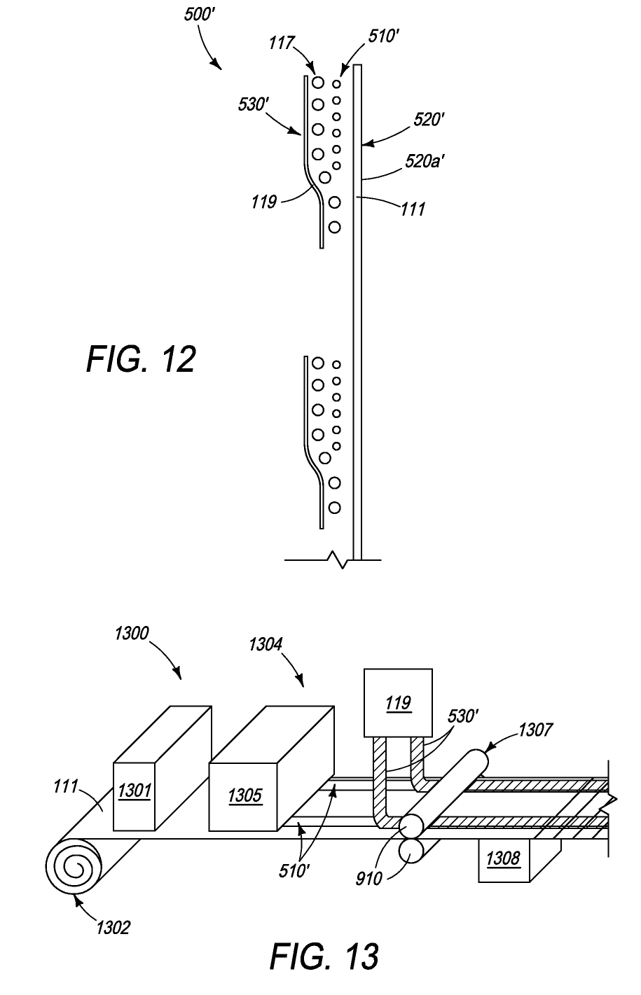

FIGS. 10 through 12 show a sheet 500′ of the supplemental labels 110 according to an embodiment. The sheet 500′ may be 8½ inches by 11 inches or any other appropriate size. A pattern of release agent (e.g., a silicone release, etc.) is introduced to a sheet 520′ of the material 111 (e.g., paper, card stock, etc.) to generally define a strip 510′ of the release agent, and a strip 530′ of the clear film 119 having adhesive 117 is placed atop the sheet 520′ to cover the strip 510′ of release agent and an area not containing the release agent. The coupling of the film 119 to the portion of the sheet 520′ without release agent is intended to be permanent, while the coupling of the film 119 to the portion of the sheet 520′ having the strip 510′ of release agent is temporary. A plurality of the supplemental labels 110 are defined by the clear film 119 and the material 111; perforations 512′ through the material 111 and the clear film 119 separate each supplemental label 110 from each other supplemental label 110. In addition, the material 111 is cut from a rear face 520a′ (e.g., not the face coupled to the clear film 119) to separate the portion of the sheet 520′ without release agent from the portion of the sheet 520′ with release agent. The cut is denoted by reference number 514′ in FIG. 11.

FIG. 13 shows a manufacturing process 1300 according to an embodiment that may be used to create the sheets 500′ of the supplemental labels 110. At a first step 1301, indicia may be printed upon the material 111, such as through a laser printer, a dot-matrix printer, or another printing device. The material 111 may be provided as a roll 1302 capable of being separated into many sheets 520′, or single sheets 520′ of the material 111 may be used. The material 111 may then proceed to step 1304, where the pattern of release agent is introduced to the material 111 using conventional equipment 1305 (e.g., a roller, sprayer, etc.) to define the strip(s) 510′.

After the strips 510′ of release agent have been defined, the strips 530′ of the clear film 119 may be introduced at step 1306 so that the adhesive 117 affixes the strips 530′ to the material 111, as shown at station 1307. Station 1307 may include traditional press equipment, such as rollers 910. The strips 530′ of the clear film 119 are located so that the clear film 119 covers the strips 510′ of release agent and a portion of the material 111 not having the release agent.

A cutting tool 1308 may then cut through the material 111 and the clear film 119, such as in a perforating action, to define a plurality of the supplemental labels 110 so that the individual supplemental labels 110 can be separated from one another. The cutting tool 1308 or another cutting tool may slit the material 111 underlying the strips 510′ of release material, making the material 111 separable from the clear film 119 where the release material has been applied. If the material 111 and/or the clear film 119 is provided in rolls, the cutting tool 1308 or another cutting tool may separate the material 111 and the clear film 119 into the sheets 500′ of the supplemental labels 110.

Returning to FIG. 10, a supplemental label 110 may be separated from a sheet 500′ by tearing the material 111 and the clear film 119 along the perforations 512′. A portion of the material 111 may then be released from the clear film 119 due to the release agent discussed above, and the released material 111 may be separated from the remaining material 111 along the slit 514′ (FIG. 11). The supplemental label 110 may then be used as generally described above in reference to FIG. 3.

Those skilled in the art appreciate that variations from the specified embodiments disclosed above are contemplated herein and that the described embodiments are not limiting. The description should not be restricted to the above embodiments, but should be measured by the following claims.

1. A supplemental label for removable attachment to an object, the supplemental label comprising:
a presentation portion having a front face, the presentation portion front face having a printable area and including a print-receiving medium; and
a coupling portion coupled to the presentation portion, the coupling portion being transparent and having opposed front and rear faces, the coupling portion rear face having an adhesive, at least a portion of the adhesive being exposed to removably couple the coupling portion to the object.

2. The supplemental label of claim 1, wherein:
the presentation portion has an end;
the coupling portion overlaps the presentation portion end; and
the adhesive affixes the coupling portion to the presentation portion where the coupling portion overlaps the presentation portion end.

3. The supplemental label of claim 2, wherein:
the coupling portion has opposed sides; and
the coupling portion sides are unbounded beyond the presentation portion end.

4. The supplemental label of claim 1, wherein:
the presentation portion has opposed ends and opposed sides that collectively define a generally rectangular shape;
the coupling portion has opposed ends and opposed sides that collectively define a generally rectangular shape having a width approximately equal to a width of the presentation portion rectangular shape;
a respective end of the coupling portion overlaps a respective end of the presentation portion; and
the presentation portion and coupling portion are coupled together only where the coupling portion overlaps the presentation portion.

5. The supplemental label of claim 1, wherein the adhesive is a transparent pressure-sensitive adhesive.

6. The supplemental label of claim 1, wherein:
the coupling portion includes a clear film; and
the presentation portion includes a paper material.

7. The supplemental label of claim 1, wherein:
the presentation portion front face includes a printable area; and
the presentation portion front face includes a print-receiving medium.

8. The supplemental label of claim 1, further comprising a material releasably coupled to the portion of the adhesive being exposed to selectively entirely cover the portion of the adhesive being exposed, wherein the material releasably coupled to the portion of the adhesive being exposed does not overlap the presentation portion.

9. A supplemental label, comprising:
a presentation portion having a front face, the front face having a printable area and including a print-receiving medium; and
a coupling portion coupled to the presentation portion and extending beyond the presentation portion, the coupling portion being transparent and having opposed front and rear faces, the coupling portion rear face having a transparent adhesive.

10. The supplemental label of claim 9, wherein:
the presentation portion has an end;
the coupling portion overlaps the presentation portion end; and
the adhesive affixes the coupling portion to the presentation portion where the coupling portion overlaps the presentation portion end.

11. The supplemental label of claim 9, wherein:
the coupling portion has opposed sides; and
the coupling portion sides are unbounded beyond the presentation portion end.

12. The supplemental label of claim 9, wherein:
the adhesive is a pressure-sensitive adhesive;
the coupling portion includes a clear film; and
the presentation portion includes a paper material.

13. A supplemental label, comprising:
a presentation portion having a front face;
a coupling portion coupled to the presentation portion and extending beyond the presentation portion, the coupling portion being transparent and having opposed front and rear faces, the coupling portion rear face having a transparent adhesive; and
a backing releasably coupled to the coupling portion rear face, whereby the presentation portion and the backing collectively entirely cover the coupling portion rear face.

14. The supplemental label of claim 13, wherein the presentation portion front face has a printable area and includes a print-receiving medium.

15. The supplemental label of claim 14, wherein the backing does not overlap the presentation portion.

16. The supplemental label of claim 13, wherein the backing does not overlap the presentation portion.

17. The supplemental label of claim 13, wherein the transparent adhesive couples the coupling portion to the presentation portion.

18. The supplemental label of claim 17, wherein:
the transparent adhesive couples the coupling portion to the backing; and
the backing includes a release material allowing the backing to be selectively separated from the coupling portion.
